(19) United States
(12) Patent Application Publication
(10) Pub. No.: US 2002/0022981 A1
(43) Pub. Date: Feb. 21, 2002

(54) Method and system for finding lowest fares for group travel

(76) Inventor: Jonathan S. Goldstein, Philadelphia, PA (US)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 09/927,166

(22) Filed: Aug. 10, 2001

Related U.S. Application Data
(60) Provisional application No. 60/224,671, filed on Aug. 11, 2000.

(51) Int. Cl. G06F 17/60

(52) U.S. Cl. 705/6

(57) ABSTRACT

A system and method of coordinating travel arrangements for a plurality of travelers. The system includes a computer system operable to receive travel information from one or more users (e.g., originating location(s), departure date(s) and arrival date(s) associated with two or more travelers). A database query engine is operable to query one or more databases for travel scheduling data based on the travel information. The computer system is operable to organize the travel scheduling data. The resulting data is presented to the user and preferably identifies lowest aggregate cost for each traveler to travel to a common destination (e.g., the same city or airport) thereby facilitating the most cost effective meeting at a common destination.

This application claims the benefit of Provisional Patent Application Ser. No. 60/224,671, filed Aug. 11, 2000.

The present invention relates generally to travel reservation systems and more particularly to systems and methods for finding the lowest fares and optimal travel routes for a group of travelers.

Travel agents generally provide services to people traveling to a meeting or convention. Some of these people may belong to one organization or entity, though the origination city may be different for some of the travelers. Travel agents can help the group find the lowest combined fare to get to a specified location. In other cases, the group may be flexible on the location of the meeting and the travel agent can find a list of possible meeting places-the travelers may pick the meeting site based upon the lowest combined cost of travel for all participants.

Currently most of the support for group travel is done by travel agents manually trying out different combinations of cities and airlines. In many cases, the travel agent does a one time check to identify a solution and the customer does not have a simple means of having the fares recalculated repeatedly until he is satisfied with his choice.

To address the shortcomings of the available art, the invention allows a user (e.g., group manager) to enter the information about each traveler in his or her group. The system is preferably connected to a data network such as the Internet and automatically checks for possible airfares from various travel sites and obtains information on all possible routes and fares. The system processes this data to find the optimal solution and presents it to the group manager.

The system generally provides two major functions:

FUNCTION ONE: Allow a group of people originating in different locations to find an optimal meeting place based on the aggregate cost of round-trip airfare; and

FUNCTION TWO: Allow a group of people to find the optimal airline flight combination based on the aggregate cost of round-trip airfare for a designated destination.

By ‘crawling’ for or accessing flight data on both a Sabre powered and a Galileo/Apollo powered system, Travel Tool is system is operable to capture 90%+ data on all available flights.

In one embodiment, the system is preferably operable to receive data input by the user via the Internet World Wide Web and ‘crawl’ Yahoo Travel and American Express Travel & Entertainment for flight details for all available destination locations (e.g., 29 Hub Airports). The 29 Hub Airports are the hubs for the 17 major US based airlines. The travel scheduling data (e.g., airline data) is preferably stored in a database (e.g., an SQL database). Price optimization is accomplished with database queries. The airline flight data is queried, aggregated by traveler and sorted by aggregate cost. An e-mail (preferably and HTML e-mail) is sent to each recipient (e.g., group manager, one or more traveler) selected to receive the results. This e-mail preferably contains at least a subset of the travel scheduling data (organized travel scheduling data), for example:

a. Summary list of 10 destinations sorted in ascending order of aggregate cost, and

b. Traveler detail of each of 10 destinations, including detailed flight (time, date and flight #) and individual round trip cost information.

If one traveler's origination does not have at least one flight to one of the 29 hub airports, an HTML e-mail message is preferably sent notifying recipients that a meeting of all parties is not possible.

In another embodiment, the system is preferably operable to receive data input by the user over the Web. The user input data includes a specific set of preferred destination locations. The system then crawls Yahoo Travel and American Express Travel & Entertainment for flight details to the selected destinations. The travel scheduling data (e.g., airline data) is stored in a SQL Database. Price optimization is accomplished with database queries. The airline flight data is queried, aggregated by traveler and sorted by aggregate cost. Preferably an HTML e-mail message is sent to each user or traveler selected to receive the results. This HTML e-mail message preferably contains:

a. Summary list of 10 flight combinations sorted in ascending order of aggregate cost,

b. Traveler detail of each of 10 flight combinations, including detailed flight (time, date and flight #) and individual round trip cost information.

Since the system can be implemented as a Web based system, users having Internet access can simply navigate to the input screen by using an ordinary Web browser. The user chooses the number of Originating Cities. The user then inputs detailed information for each Originating City, including:

1. Arrival and Departure Dates

2. Number of Travelers

3. Group Name

4. e-mail Address (at least one should be supplied)

5. Checkbox to Receive e-mail Results (at least one should be chosen)

6. Checkbox to Constrain Results to Originating City

7. Drop-Down List for Airport-Airport Code

### SUMMARY OF THE INVENTION

The invention is directed to a system and method of coordinating travel arrangements for a plurality of travelers. A first originating location, a first departure date and/or a first arrival date are received in association with a first traveler. A second originating location, a second departure date and/or a second arrival date are received in association with second traveler. A database is queried for travel scheduling data based on the first and second originating location and at first and second departure and/or arrival dates. The travel scheduling data includes at least one of a cost, departure date, arrival date, originating location and a destination location. The travel scheduling data is organized at least partially based on the cost for the first and second traveler to travel from the first and second originating locations to at least one destination location. At least a portion of the organized travel scheduling data is then presented to a user.

In a typical application, the travel scheduling data is airline flight data. In the airline context, the first and second originating locations are airports. The destination location can also be an airport.

Other aspects of the invention optionally include travel scheduling data having multiple destination locations. The travel scheduling data can optionally include data from a plurality of carriers. The travel scheduling data can optionally be organized by traveler. The travel scheduling data can optionally be organized by destination location. The travel scheduling data can also be organized by an aggregate cost for the first and second traveler to travel from the first and second originating locations to at least one destination location.

Other aspects of the invention optionally include receiving at least one preferred destination location and the database is queried at least partially based on the preferred destination location. At least a portion of the organized travel scheduling data can be transmitted to a user via an e-mail message.

A system in accordance with the invention generally includes a computer system and a database query engine. The computer system is operable to receive at least a first originating location and at least one of a first departure date and a first arrival date associated with a first traveler. The computer system is also operable to receive at least a second originating location and at least one of a second departure date and a second arrival date associated with a second traveler. The database query engine is operable to query at least one database for travel scheduling data. The query is generally based on the first and second originating location and at least one of the first and second departure and arrival dates. The travel scheduling data has at least one of a cost, departure date, arrival date, originating location and a destination location. The computer system is operable to organize the travel scheduling data at least partially based on the cost for the first and second traveler to travel from the first and second originating locations to at least one destination location. The computer system is also operable to present at least a portion of the organized travel scheduling data to a user.

### BRIEF DESCRIPTION OF THE DRAWINGS

FIG. 1 shows a basic block diagram of a system in accordance with the invention.

FIG. 2 shows a flow chart describing operation of a system and method in accordance with the invention.

FIG. 3 shows an exemplary input screen in accordance with the invention.

FIG. 4 shows an exemplary thank you screen in accordance with the invention.

FIG. 5 shows exemplary input data stored in a database in accordance with the invention.

FIG. 6 shows exemplary travel scheduling data (craw data) stored in a database in accordance with the invention.

FIG. 7 shows exemplary summary results for presentation to a user in accordance with the invention.

FIG. 8 shows exemplary detailed summary results for presentation to a user in accordance with the invention.

### DETAILED DESCRIPTION OF THE INVENTION

The invention concerns a system and method of coordinating travel arrangements for a plurality of travelers. The system includes a computer system operable to receive travel information from one or more users (e.g., originating location(s), departure date(s) and arrival date(s) associated with two or more travelers). A database query engine is operable to query one or more databases for travel scheduling data based on the travel information. The computer system is operable to organize the travel scheduling data and present the data to the user. Preferably, the organized travel scheduling data includes travel information from each originating location to a plurality of destinations whereby the most convenient destination can then be selected.

For example, the computer system can provide travel information from each originating location to several different destinations. The lowest aggregate cost for each traveler to travel to a common destination (e.g., the same city or airport) can then be selected. Preferably, all of the travelers can be scheduled to arrive at the common destination at approximately the same date and time thereby facilitating the most cost effective meeting at a common destination.

The terms “present” or “presenting” as used herein are used in their ordinary sense and include displaying or playing audio and/or visual information to a user. Communication between the user and the computer system is preferably carried out via a data network such as the Internet. The data network generally includes a plurality of nodes such as a user network processing device or client (i.e., a PC and Web Browser), the computer system (e.g., including a server and the associated hardware and software) and one or more databases coupled in data communication.

The term “coupled” as recited herein is used in its broadest sense and does not require a physical connection between devices. Two or more devices as disclosed herein are “coupled” so long as data communication between the devices is possible (e.g., hard wired data communication, wireless data communications and the like).

The term “user network processing device” generally refers to any user operable device having access to the data network including but not limited to a personal computer (portable or desktop), personal digital assistant (PDA), Browser phone, 2-way pager or the like. The user network processing device can be operated by an individual or may be programmed to operate automatically (i.e., timed schedule or triggered by an external event). Thus, the term “user” as recited herein encompasses an individual as well as a computerized device operable to access the data network and perform computer automated functions.

In the context of the Internet, the user network processing device and computer system preferably communicate via TCP/IP protocol (Transmission Control Protocol over Internet Protocol). External databases such as Yahoo Travel and American Express Travel & Entertainment are preferably also accessible via TCP/IP protocol, FTP protocol or the like.

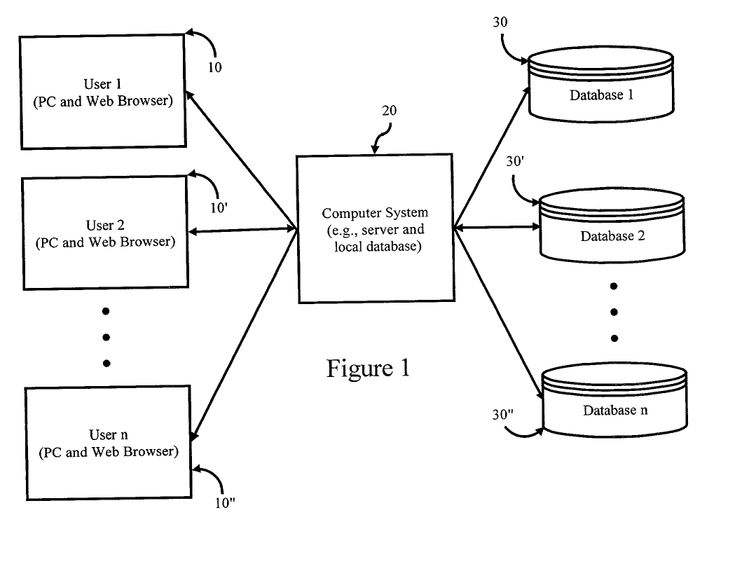

FIG. 1 shows a general block diagram of a plurality of user network processing devices (user PC and Web Browsers 10, 10′, 10″), a computer system 20, and databases (30, 30′, 30″) in accordance with the invention. It is understood that a virtually unlimited number of users and databases can be associated with the computer system. In this regard, FIG. 1 shows User n, 10″ and Database n, 30″ (where n can be any positive number). Further disclosure with respect to the user network processing devices and databases will refer to User 1, 10 and Database 1, 30. It is understood that this disclosure pertains to other user network processing devices and databases as well.

FIG. 1 generally shows the data communications paths between the user PC and Web Browser 10, computer system 20 and database 30. It is understood that data communications via the Internet often traverse a series of intermediate network nodes prior to reaching the desired destination (e.g., the user PC and Web Browser or the content provider Web site). The arrows shown in FIG. 1 do not suggest a direct physical connection between the users, computer system and databases and encompass typical network and/or Internet communications (a connectionless, best-efforts packet-based system). It is also understood that other data networks using various network protocols are suitable for use in accordance with the invention. For matters of simplicity, the Databases shown in FIG. 1 are shown external to the computer system. It is understood that the databases can also be internal or local to the computer system.

The user PC and Web Browser 10 is operable to accesses the Internet World Wide Web (WWW or Web). The user PC is preferably has an associated operating system such as Microsoft Windows or Linux and includes a typical Web Browser such as Netscape Communicator (for Windows or Linux) or Microsoft Internet Explorer, as well as numerous others. The Web Browser assists the user in requesting and displaying Web pages or sites containing desired information. The hardware and software configuration of a user network processing device for Internet access is routine and generally known to those skilled in the art.

The computer system 20 preferably includes one or more HTTP server hosting a Web site. There are many varieties of commercially or publicly available World Wide Web server software packages which are compatible with the invention (e.g., Apache, IBM WebSphere products, NETSCAPE Enterprise, Microsoft Windows 2000 Server and the like) all of which can be implemented with commonly available hardware from vendors such as IBM, Hewlett Packard, Compaq, Dell, Sun and numerous others that are known to those skilled in the art.

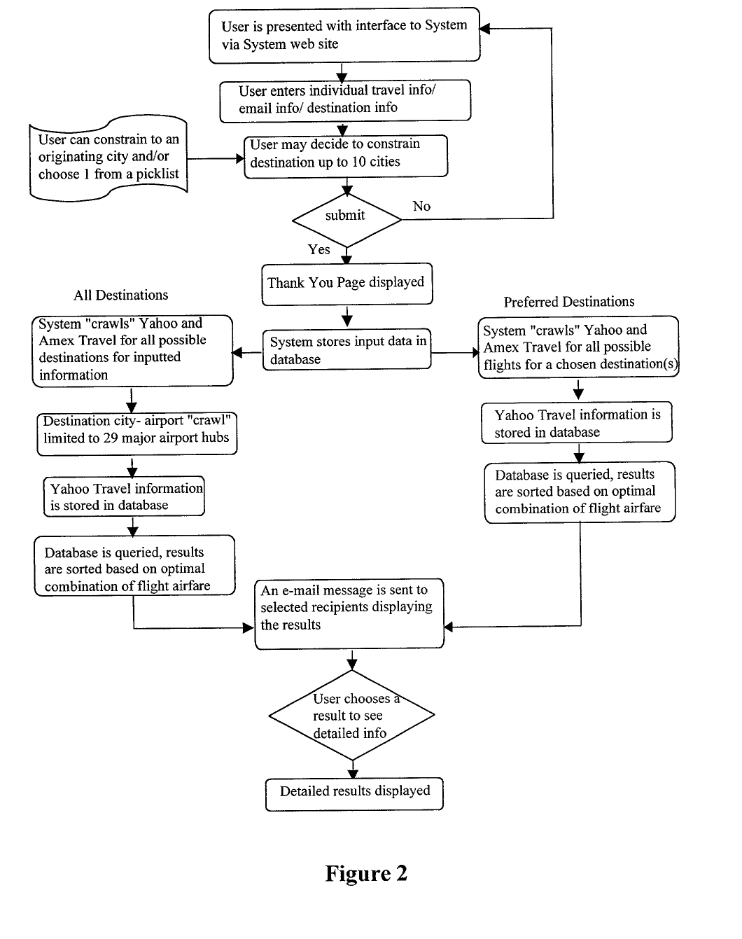

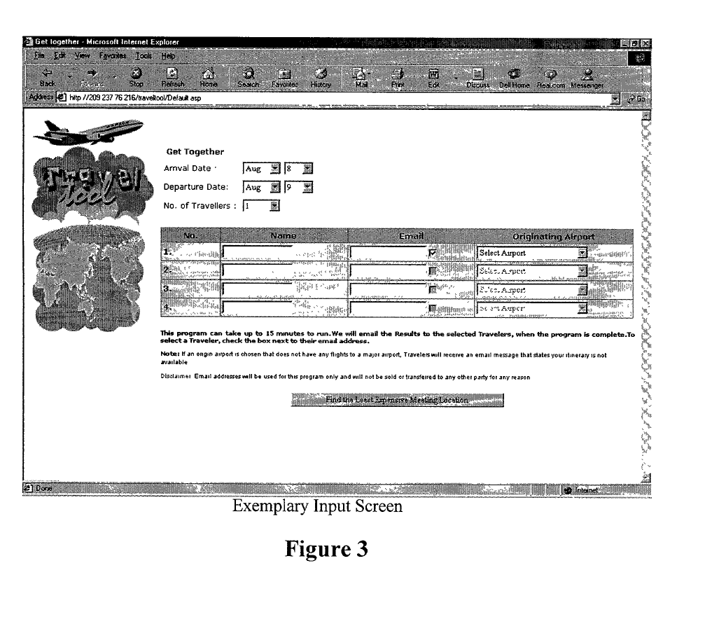

Operation of the system is shown graphically in FIG. 2. Preferably, a users accesses the system via the Internet and is presented with a graphical interface for data entry. Preferably, the user enters travel information associated with one or more traveler and at least one e-mail address. See FIG. 3. Travel information preferably includes a departure date, arrival date, number of travelers, a traveler name and originating airport associated with each traveler and at least one e-mail address. Originating airports are preferably provided via a pick list or the like and preferably use ICAO/IATA/FAA locators. The system can then provide information on the various common meeting locations including the least expensive meeting location based on the user input as discussed in detail below.

FIG. 2 includes only the basic processing steps associated with the invention. It is understood that other processing steps may be required to implement a commercial system in accordance with the invention. For example, the user input should be checked for errors. If one traveler's origination does not have at least one available flight to one of the possible destination locations or cities (e.g., one of the 29 hub airports), an error notification is preferably issued. The system may also provide for additional data collection steps and may present the user with promotional opportunities, advertisements and the like. It is understood that these and other routine variations in data processing are within the scope of the invention.

Processing of the user's information may take several minutes. Accordingly, results are preferably sent to one or more e-mail addresses supplied by the user. In the alternative, the results can be supplied to the user in real time. It is understood that significant data processing capabilities and network bandwidth may be required to operate the system in real time.

Users can optionally be required to sign-up or register before using the system (e.g., select a user name and password). Users may also be charged a membership fee (e.g., a onetime fee, periodic fee, transaction-based fee or the like). The creation and administration of user profiles is well known in the art and need not be disclosed further. The system may provide for on-line electronic payments (e.g., credit card, debit card or the like) as is also well known in the art. It is also understood that web pages requiring private information such as payment and billing information can be provided with enhanced security such as SSL, a secure server or the like.

Preferably, the system is operable to identify a plurality of common meeting locations or cities. Preferably, these meeting locations are associated with the major hub airports (e.g., one of the 29 hub airports currently servicing the 17 major US based airlines). These meeting locations are ideal because extensive flight information is available for these airports. Optionally, the user can limit or constrain the number of destination cities. In this case, the user is ultimately presented with results limited to the selected destinations.

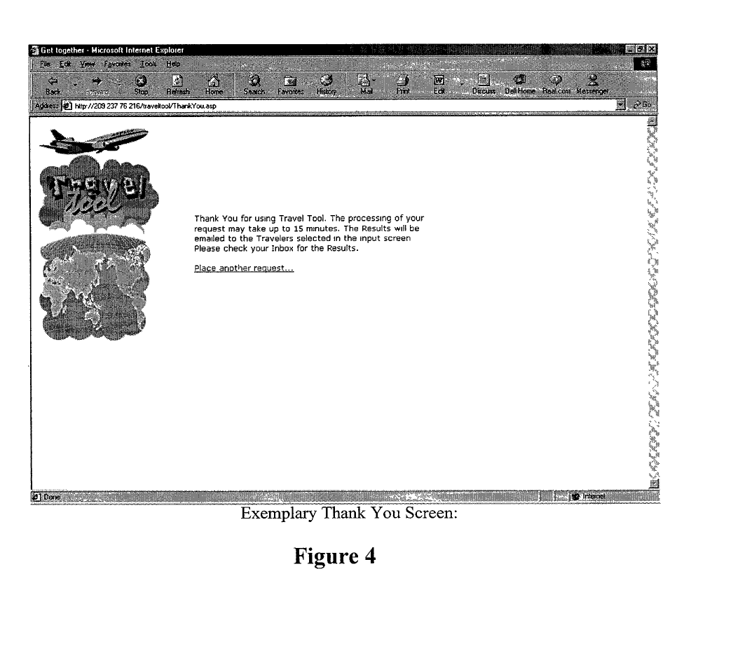

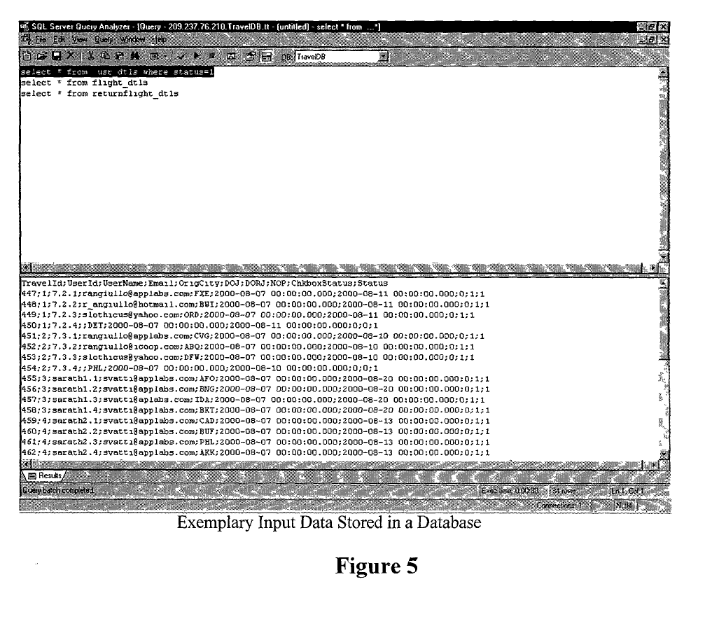

Once the user inputs the required information, the system preferably displays a thank you or confirmation page. See FIG. 4. The system preferably stores the user input data in a database. FIG. 5 shows exemplary database records in accordance with the invention. It is understood that the user input data can be stored in a variety formats. In this example, a database record is associated with each traveler. For example a database record for use in accordance with the invention can contain the following fields (as well as others not shown):

TravelId: A unique ID code associated with each group of travelers;

UserId A unique ID code associated with each User;

UserName A user name associated with the UserId;

e-mail An e-mail address associated with a user, traveler or group;

OrigCity: A traveler's originating city (e.g., ICAO/IATA/FAA locators);

DOJ: Date of the journey;

DORJ: Date of the return journey; and

ChkboxStatus: Check Box flag (whether traveler will receive e-mail results).

Regardless of how the data is stored, the system ultimately searches for available airline flights that matches the user input data (i.e., having the proper originating airport, departure date and the like). Assuming the user does not elect to constrain the number of destination cities, the system searches one or more databases for all possible destinations matching the user input data. If the user elects to constrain the number of destination cities, the system searches one or more databases for the selected destinations matching the user input data.

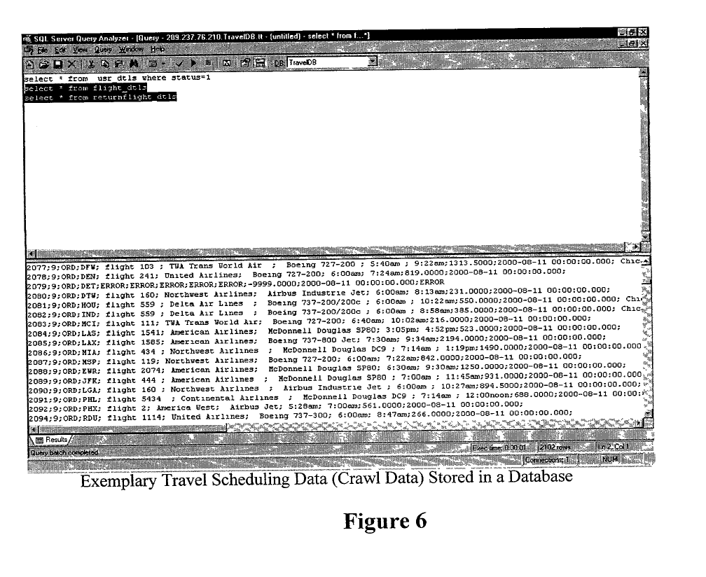

In a preferred embodiment, the system ‘crawls’ for travel scheduling data (e.g., airline flight data) on both a Sabre powered and a Galileo/Apollo powered database system. This provides very complete data on all available flights. The information is then stored, preferably in a database that is locally accessible to the computer system. See FIG. 6. The local database is then queried and the optimal destinations are identified (e.g., based on airfare). This configuration minimizes the storage requirements for the travel scheduling data since the data is only retrieved and stored temporarily in response to user input.

It is understood that the system can be implemented using one or more local databases containing essentially complete data on all available flights. This configuration would necessarily require substantial storage requirements as well as periodic update and maintenance of the travel scheduling data. It is understood that these and other variations relating to the source and storage mode of available flight data are encompassed by the invention.

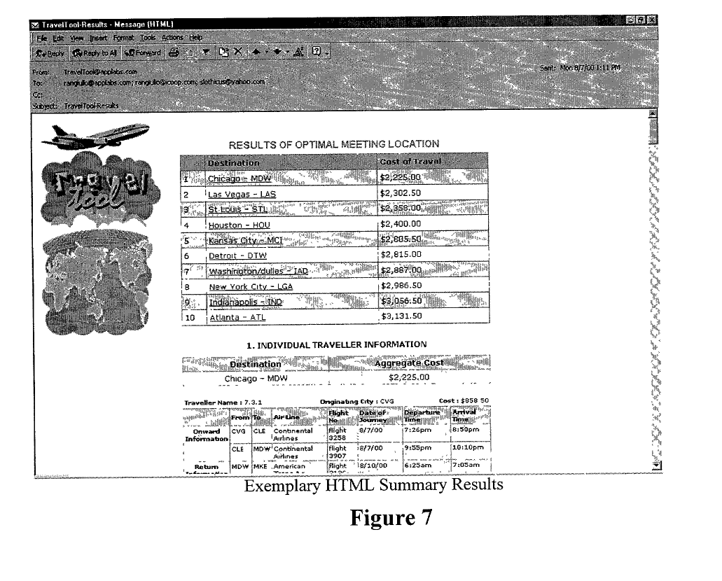

The system is preferably operable to find an optimal meeting place based on the aggregate cost of round-trip airfare. Preferably, the system identifies the lowest cost airfare for each traveler to travel to each possible destination airport or city. The system then calculates the aggregate airfare for all travelers to travel to each possible destination airport or city. The results are then preferably sorted (i.e., organized travel scheduling data) and at least a portion is presented to the user. See FIG. 7. In the exemplary results, ten meeting locations are presented in ascending order of aggregate cost. It is understood that fewer or more meeting locations can be presented to the user. The formulation of the required database queries and sorting techniques required to implement the invention are well within the scope of one skilled in the art and need not be discussed further.

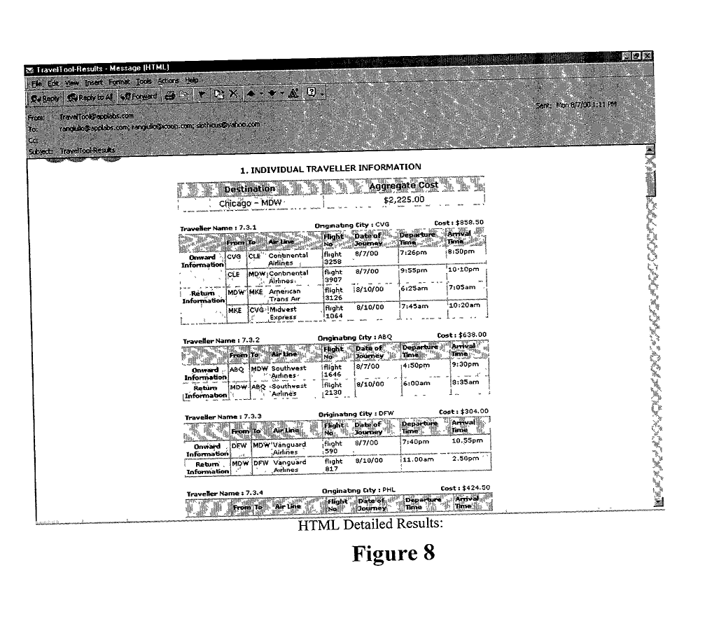

As discussed above, the results are preferably e-mailed to the user input e-mail addresses. FIG. 7 shows an exemplary e-mail result in HTML format. It is understood that results can be provided in a variety of formats including in real-time via the system website. Users can optionally receive detailed results. See FIG. 8. Preferably, the detailed results provide all relevant travel related details including individual flight costs, flight numbers for all relevant flights (including non-stop and connecting flights), departure times, arrival times and the like.

The following terms shall have, for the purposes of this application, the respective meanings set forth below.

Client: generally refers to a computer system or process that requests a service of another computer system or process (e.g., a “server”) using some kind of protocol and accepts the server's responses. A client is part of a client-server software architecture.

Database: generally refers to a collection of information stored for later retrieval. Traditional databases are organized by fields, records, and files. A field is a single piece of information; a record is one complete set of fields; and a file is a collection of records. The term “database” is used herein in its broadest sense (i.e., a collection of information) and is not limited to any particular structure or implementation.

Database Query Engine: generally refers to a piece of software operable to query a database for relevant information.

Data network: generally refers to a group of two or more computer systems linked together in data communication. The term “data network” encompasses any type of wired or wireless computer network, independent of protocol, including local-area networks (LANs), wide-area networks (WANs) and networks of networks including the an intranet, extranet and the Internet.

HTML: generally stands for “Hyper-Text Markup Language”, the authoring language used to create documents on the World Wide Web. HTML defines the structure and layout of a Web document by using a variety of tags and attributes.

Query: generally refers to a request for information, including but not limited to a formal request to a database or search engine.

Query Results: generally refers to information returned in response to a query. Query results typically include a subset of information contained in the database. Query results may also include all of the information contained in the database or no information from the database (e.g., an error message or null).

Relational Database: A database generally built on a relationship model in which data is organized in tables. The set of names of the table columns is called the “schema” of the table. Data can be manipulated using a relational algebra. SQL is a standard language for communicating with and/or querying a database built on the relational model.

Server: generally refers to a program running on a computer that provides some service to other (e.g., client) programs. The connection between client and server is normally by means of message passing, often over a network, and uses some protocol to encode the client's requests and the server's responses.

SQL: generally refers to “structured query language”, a standardized query language for requesting information from a database.

Travel Scheduling Data: generally refers to data identifying at least one of a cost, departure date, arrival date, originating location and a destination location for a given method of transportation (e.g., airline flight information).

While this invention has been described with an emphasis upon preferred embodiments, it will be obvious to those of ordinary skill in the art that variations in the preferred devices and methods may be used and that it is intended that the invention may be practiced otherwise than as specifically described herein.

For example, the invention can include additional user data used to further constrain the output results. For example, limited time and date ranges for departures and arrivals, nonstop flights only, limitations with respect to specific airlines or equipment and the like. Accordingly, this invention includes all modifications encompassed within the spirit and scope of the invention as defined by the claims that follow.

What is claimed is:

1. A method of coordinating travel arrangements for a plurality of travelers comprising:
a) receiving at least a first originating location and at least one of a first departure date and a first arrival date associated with a first traveler;
b) receiving at least a second originating location and at least one of a second departure date and a second arrival date associated with a second traveler;
c) querying at least one database for travel scheduling data based on the first and second originating location and at least one of the first and second departure and arrival dates, the travel scheduling data having at least one of a cost, departure date, arrival date, originating location and a destination location;
d) organizing the travel scheduling data at least partially based on the cost for the first and second traveler to travel from the first and second originating locations to at least one destination location; and
e) presenting at least a portion of the organized travel scheduling data.

2. The method of claim 1 wherein the travel scheduling data includes multiple destination locations.

3. The method of claim 1 wherein the travel scheduling data includes data from a plurality of carriers.

4. The method of claim 1 wherein the travel scheduling data is organized by traveler.

5. The method of claim 1 wherein the travel scheduling data is organized by destination location.

6. The method of claim 1 wherein the travel scheduling data is organized by an aggregate cost for the first and second traveler to travel from the first and second originating locations to at least one destination location.

7. The method of claim 1 wherein the travel scheduling data is airline flight data.

8. The method of claim 1 wherein the first and second originating locations are airports.

9. The method of claim 1 wherein the destination location is an airport.

10. The method of claim 1 further comprising receiving at least one preferred destination location and the database is queried at least partially based on the preferred destination location.

11 The method of claim 1 further comprising transmitting at least a portion of the organized travel scheduling data via an e-mail message.

12. A system for coordinating travel arrangements for a plurality of travelers comprising:
a computer system operable to receive at least a first originating location and at least one of a first departure date and a first arrival date associated with a first traveler, the computer system also being operable to receive at least a second originating location and at least one of a second departure date and a second arrival date associated with a second traveler, and
a database query engine operable to query at least one database for travel scheduling data based on the first and second originating location and at least one of the first and second departure and arrival dates, the travel scheduling data having at least one of a cost, departure date, arrival date, originating location and a destination location; wherein the computer system is operable to organize the travel scheduling data at least partially based on the cost for the first and second traveler to travel from the first and second originating locations to at least one destination location; and present at least a portion of the organized travel scheduling data.

13. The system of claim 12 wherein the travel scheduling data includes multiple destination locations.

14. The system of claim 12 wherein the travel scheduling data includes data from a plurality of carriers.

15. The system of claim 12 wherein the travel scheduling data is organized by traveler.

16. The system of claim 12 wherein the travel scheduling data is organized by destination location.

17. The system of claim 12 wherein the travel scheduling data is organized by an aggregate cost for the first and second traveler to travel from the first and second originating locations to at least one destination location.

18. The system of claim 12 wherein the travel scheduling data is airline flight data.

19. The system of claim 12 wherein the first and second originating locations are airports.

20. The system of claim 12 wherein the destination location is an airport.

21. The system of claim 12 wherein the computer system is operable to receive at least one preferred destination location and the database is queried at least partially based on the preferred destination location.

22 The system of claim 12 wherein the computer system transmit at least a portion of the organized travel scheduling data via an e-mail message.

23. A method of coordinating airline travel arrangements for a plurality of travelers comprising:
a) receiving at least a first originating airport and at least one of a first departure date and a first arrival date associated with a first airline traveler;
b) receiving at least a second originating airport and at least one of a second departure date and a second arrival date associated with a second airline traveler;
c) querying at least one database for airline travel scheduling data based on the first and second originating airport and at least one of the first and second departure and arrival dates, the travel scheduling data having at least one of a cost, departure date, arrival date, originating airport and a destination airport;
d) organizing the airline travel scheduling data at least partially based on an aggregate cost for the first and second airline travelers to travel from the first and second originating airports to at least one destination airport; and
e) presenting at least a portion of the organized airline travel scheduling data.

24. A system for coordinating travel arrangements for a plurality of airline travelers comprising:
a computer system operable to receive at least a first originating airport and at least one of a first departure date and a first arrival date associated with a first airline traveler and at least a second originating airport and at least one of a second departure date and a second arrival date associated with a second airline traveler,
a database query engine operable to query at least one database for airline travel scheduling data based on the first and second originating location and at least one of the first and second departure and arrival dates, the airline travel scheduling data having at least one of a cost, departure date, arrival date, originating airport and a destination airport; wherein the computer system is operable to organize the airline travel scheduling data at least partially based on an aggregate cost for the first and second airline traveler to travel from the first and second originating airports to at least one destination airport; and present at least a portion of the organized airline travel scheduling data.
